(19) United States
(12) Patent Application Publication
(10) Pub. No.: US 2010/0332225 A1
(43) Pub. Date: Dec. 30, 2010

(54) TRANSCRIPT ALIGNMENT

(75) Inventors: Jon A. Arrowood, Smyrna, GA (US); Kenneth King Griggs, Roswell, GA (US); Marsal Gavalda, Sandy Springs, GA (US); Robert W. Morris, Atlanta, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/493,786

(22) Filed: Jun. 29, 2009

(51) Int. Cl. G10L 15/26; G06F 17/30

(52) U.S. Cl. 704/235; 704/E15.043; 707/759; 707/769; 707/705; 707/802

(57) ABSTRACT

Some general aspects relate to systems and methods for media processing. One aspect, for example, relates to a method for aligning multimedia recording with a transcript. A group of search terms are formed from the transcript, with each search term being associated with a location within the transcript. Putative locations of the search terms are determined in a time interval of the multimedia recording. For each search term, zero or more putative locations are determined and, for at least some of the search terms, multiple putative locations are determined in the time interval of the multimedia recording. According to a first sequencing constraint, a first representation of a group of sequences each of a subset of the putative locations of the search terms is formed. A second representation of a group of sequences each of a subset of the search terms is formed. Using the first and the second representations, the time interval of the multimedia recording is partially aligned with the transcript.

### CROSS-REFERENCE TO RELATED APPLICATIONS

This application is related to U.S. application Ser. No. 12/351,991 (Attorney Docket No. 30004-003003), filed Jan. 12, 2009, and U.S. application Ser. No. 12/469,916 (Attorney Docket No. 30004-039001), filed May 21, 2009. The contents of above applications are incorporated herein by reference.

### BACKGROUND

This application relates to alignment of multimedia recordings with transcripts of the recordings.

Many current speech recognition systems include tools to form “forced alignment” of transcripts to audio recordings, typically for the purposes of training (estimating parameters for) a speech recognizer. One such tool was a part of the HTK (Hidden Markov Model Toolkit), called the Aligner, which was distributed by Entropic Research Laboratories. The Carnegie-Mellon Sphinx-II speech recognition system is also capable of running in forced alignment mode, as is the freely available Mississippi State speech recognizer.

The systems identified above force-fit the audio data to the transcript. In some approaches, the transcript is represented as a network to form an alignment of the audio data to the transcript.

### SUMMARY

In some general aspects, the audio data is processed to form a representation of multiple putative locations of search terms in the audio. A representation of the transcript is processed according to the representation of the multiple putative locations of the search terms to create an alignment of the audio with the transcript. In some embodiments, the processing of the audio data (e.g., locating a set of search terms using a word-spotting technique) generates a network in the form of a finite transducer representing the search results, and the processing of the transcript generates a second network representing the transcript also in the form of a finite transducer. These two transducers are composed to determine the alignment of the audio with the transcript.

Some general aspects relate to systems and methods for media processing. One aspect relates to a method for aligning multimedia recording with a transcript. A group of search terms are formed from the transcript, with each search term being associated with a location within the transcript. Putative locations of the search terms are determined in a time interval of the multimedia recording. For each search term, zero or more putative locations are determined and, for at least some of the search terms, multiple putative locations are determined in the time interval of the multimedia recording. According to a first sequencing constraint, a first representation of a group of sequences each of a subset of the putative locations of the search terms is formed. A second representation of a group of sequences each of a subset of the search terms is formed. Using the first and the second representations, the time interval of the multimedia recording is partially aligned with the transcript.

Embodiments may include one or more of the following features.

The second representation of the group of sequences each of a subset of the search terms may be formed according to a second sequencing constraint.

The first sequencing constraint includes a time sequencing constraint. The time sequencing constraint may include a substantially chronological sequencing constraint.

In some embodiments, the first and the second representation respectively includes a first and a second network representation, such as a first and a second finite state network representation. The first and the second finite state network representation may respectively include a first and a second finite state transducer. To partially align the time interval of the multimedia recording and the transcript, the first finite state transducer is composed with the second finite state transducer.

In determining putative locations of the search terms in a time interval of the multimedia recording, each of the putative locations is associated with a score characterizing a quality of a match of the search term and the corresponding putative location. In forming the first representation, a respective score is determined for each sequence of subset of putative locations of the search terms using the scores of the putative locations of the search terms in the sequence.

Partially aligning the time interval of the multimedia recording and the transcript includes forming at least a partial alignment between a sequence of subset of the putative locations of the search terms and a sequence of search terms. Forming the partial alignment includes determining a score for the partial alignment based at least on the score of the sequence of subset of the putative locations.

The multimedia recording includes an audio recording and/or a video recording.

Forming the search terms includes forming one or more search terms for each of a plurality of segments of the transcript. Forming the search terms may further include forming one or more search terms for each of a plurality of text lines of the transcript.

The putative locations of the search terms may be determined by applying a wordspotting approach to determine one or more putative locations for each of the search terms.

In some embodiments, the representation of the transcript may be in the form of a multi-layer network. For example, at a first layer, contextual-dependent phonemes can be represented by a network. At a second layer, words can be defined by a network of phonemes that specify multiple possible pronunciations. At a third layer, a network can be used to define how words are connected, for instance, using a finite state grammar or n-gram network. This multi-layer network can be further extended in several ways. For instance, one extension allows contextual pronunciation to change at word boundaries (such as converting “did you” into “didja”). Another extension includes adding noise/silence/garbage states that allow large untranscribed chunks of audio to be skipped. A further extension includes adding skip states into and out of the network to handle cases when there are large chunks of transcription that do not have representative speech appearance in the audio.

Embodiments of various aspects may include one or more of the following advantages.

In some embodiments, forming the network representation of the search results and combining it with the network representation of the transcript can provide robust transcript alignment with reduced computational cost and reduced error rate as compared to solely forming the network representation of the transcript.

Other features and advantages of the invention are apparent from the following description, and from the claims.

### DESCRIPTION OF DRAWINGS

FIG. 1 is a diagram of a transcript alignment system.

FIG. 2 shows an example of a wordspotting search result.

FIG. 3 shows one embodiment of a network representation of the search result of FIG. 2.

FIG. 4 shows an alternative embodiment of the network representation of the search result of FIG. 2.

FIG. 5 shows one embodiment of a network representation of the transcript used in FIG. 2.

FIG. 6 shows another embodiment of a network representation of the transcript used in FIG. 2.

FIG. 7 shows a further embodiment of a network representation of the transcript used in FIG. 2.

### DETAILED DESCRIPTION

### 1 OVERVIEW

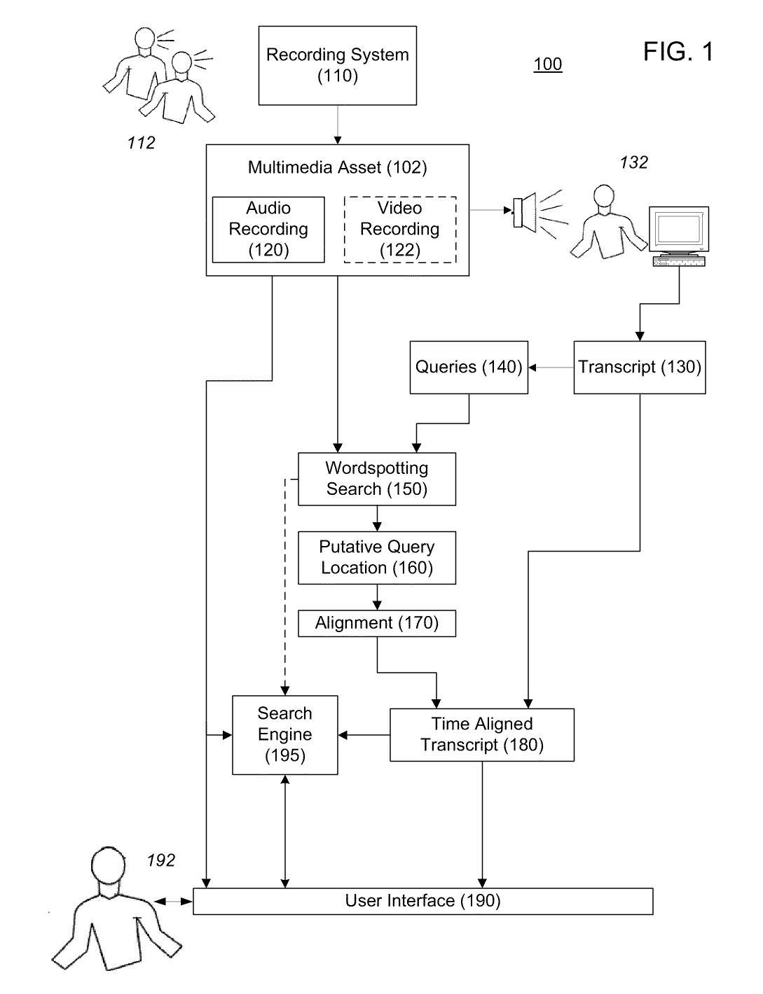

Referring to FIG. 1, a transcript alignment system 100 is used to process a multimedia asset 102 that includes an audio recording 120 (and optionally a video recording 122) of the speech of one or more speakers 112 that have been recorded through a conventional recording system 110. A transcript 130 of the audio recording 120 is also processed by the system 100. As illustrated in FIG. 1, a transcriptionist 132 has listened to some or all of audio recording 120 and entered a text transcription on a keyboard. Alternatively, transcriptionist 132 has listened to speakers 112 live and entered the text transcription at the time speakers 112 spoke. Further, the transcript may be pre-existing—for example, consider a movie script. In this case, the transcript exists prior to the audio, and may not match the audio due to improvisation or editing. The transcript 130 is not necessarily complete. That is, there may be portions of the speech that are not transcribed. The transcript 130 may also have substantial portions that include only background noise when the speakers were not speaking. The transcript 130 is not necessarily accurate. For example, words may be misrepresented in the transcript 130. Furthermore, the transcript 130 may have text that does not reflect specific words spoken, such as annotations or headings, or may contain transcript lines from other scenes not in this recording.

Generally, alignment of the audio recording 120 and the transcript 130 is performed in a number of phases. First, the text of the transcript 130 is processed to form a number of queries 140, each query being formed from a segment of the transcript 130, such as from a single line of the transcript 130. The location in transcript 130 of the source segment for each query is stored with the queries. A wordspotting-based query search 150 is used to identify putative query location 160 in the audio recording 120. For each query, a number of time locations in audio recording 120 are identified as possible locations where that query term was spoken. Each of the putative query locations is associated with a score that characterizes the quality of the match between the query and the audio recording 120 at that location. An alignment procedure 170 is used to match the queries with particular of the putative locations. This matching procedure is used to form a time-aligned transcript 180. The time-aligned transcript 180 includes an annotation of the start time for each line of the original transcript 130 that is located in the audio recording 120. A user 192 then browses the combined audio recording 120 and time-aligned transcript 180 using a user interface 190. One feature of this interface 190 is that the user can use a wordspotting-based search engine 195 to locate search terms. The search engine uses both the text of time-aligned transcript 180 and audio recording 120. For example, if the search term was spoken but not transcribed, or transcribed incorrectly, the search of the audio recording 120 may still locate the desired portion of the recording. User interface 190 provides a time-synchronized display so that the audio recording 120 for a portion of the text transcription can be played to the user 192.

Transcript alignment system 100 makes use of wordspotting technology in the wordspotting query search procedure 150 and in search engine 195. One implementation of a suitable wordspotting based search engine is described in U.S. Pat. No. 7,263,484, filed on Mar. 5, 2001, the contents of which are incorporated herein by reference. The wordspotting based search approach of this system has the capability to:
accept a search term as input and provides a collection of results back with a confidence score and time onset and offset for each
allow a user to specify the number of search results to be returned, which may be unrelated to the number of actual occurrences of the search term in the audio.

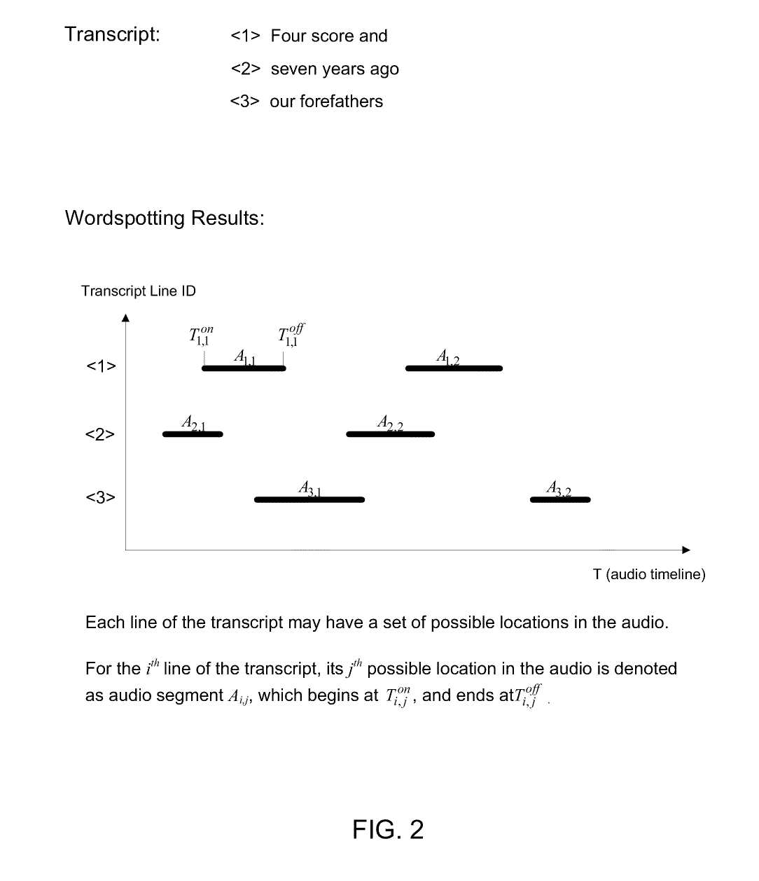

FIG. 2 shows one example of a transcript from which three queries (in this example, search terms) are formed and processed by the wordspotting procedure to identify their putative locations in the audio recording. Each search term is formed from a respective text line of the transcript, indexed as Line <1>, <2>, and <3>. Note that in this description, a line is not necessarily associated with a sentence-level segment of the transcript. It can refer to a set of one or more textual elements that are grouped in a variety of forms, including for example, a paragraph consisting of multiple sentences, a single sentence, a single clause, a contiguous string of words (e.g., formed by syntactic, semantic, or punctuation-based segmentation), a phrase, and a single word.

In the example of FIG. 2, the wordspotting search 150 returned two “hits” (putative locations in the audio) for each line of the transcript, although in other examples, the number of hits for different lines is not necessarily the same. The time onset and offset of an audio segment Aᵢⱼ associated with the j^{th} hit of the i^{th} line of the transcript are identified as [T_{i,j}^{on}, T_{i,j}^{off}]. Each hit is associated with a corresponding confidence score (not shown) characterizing the quality of the match between the line and the putative location of the line in the audio.

Using the results of the wordspotting search, the transcript alignment system 100 attempts to align lines of the transcript 130 with a time index into audio recording 120. One approach to the overall alignment procedure carried out by the transcript alignment system 100 consists of three main, largely independent phases, executed one after the other: gap alignment, optimized alignment, and blind alignment. The first two phases each align as many of the lines of the transcript to a time index into the media, and the last then uses best-guess, blind estimation to align any lines that could not otherwise be aligned. One implementation of a suitable transcript alignment system that implements these techniques is described in U.S. application Ser. No. 12/351,991, filed Jan. 12, 2009. Such as a transcript alignment system can produce transcript alignments that are robust to transcription gaps and errors, for example, when the transcript has missing words and/or spelling errors.

Another approach to the alignment procedure applies sequencing constraints to first find a set of acceptable sequences of subsets of the search results and a set of acceptable sequences of lines of the transcript, and then matches these two sets of acceptable sequences to identify the most likely sequence(s) of lines of the transcript in alignment with the media. Such an approach can produce accurate transcript alignment even in cases where the transcript is not verbatim with the media, for example, when the transcript has substantial portions that are either not represented in the media or instead represented multiple times in the media, when the transcript does not cover the full content of the media, and when the transcript is presented in an arrangement substantially out of order with the timeline of the media. Embodiments of this approach are discussed in detail below.

In some embodiments, the approach makes use of techniques of combining finite state networks to conduct the match in a computationally efficient manner. More specifically, a first finite state network is formed representing the set of acceptable sequences of subsets of the search results according to a first sequencing constraint. A second finite state network is formed representing the set of acceptable sequences of lines of the transcript according to a second sequencing constraint. Alignment of the time interval of the media and the transcript is achieved as a result of combining the first finite state network with the second finite state network. A scoring mechanism is provided for determining the most likely sequence of lines of the transcript from the result of alignment.

There are many possible ways to form representations of finite state networks. One particular representation of a finite state network makes use of a finite state transducer (FST), one embodiment of which is described in detail below. Note that other embodiments of the finite state transducer, or more generally, other representations of finite state networks are also possible.

### 2 TRANSCRIPT ALIGNMENT USING FINITE STATE TRANSDUCERS (FST)

In one form, a weighted finite state transducer T can be described as a tuple T=(A, B, Q, I, F, E, σ, λ, ρ), where
A represents the input alphabets of the transducer;
B represents the output alphabets of the transducer;
Q represents a finite set of states in the transducer;
I ∈ Q represents the initial state;
F ∈ Q represents the final state;
E represents the state transition function that maps Q×A to Q;
σ represents the output function that maps Q×A to B;
λ represents the weight on the initial state I; and
ρ represents the weight on the final state F.

Generally, the input and output states I, F of the transducer respectively allows entry into and exit from the transducer. The state transition function E provides two types of transitions between the states Q, including ε-transitions that allows the FST to advance from one state to another (or to itself) with an ε (null) output, and non-ε transitions each of which is associated with an output alphabet that belongs to B. In some examples, the input alphabets A can be omitted, in which case the finite state transducer becomes a finite state automation—a special case of FST.

### 2.1 FST REPRESENTATION OF THE SEARCH RESULTS

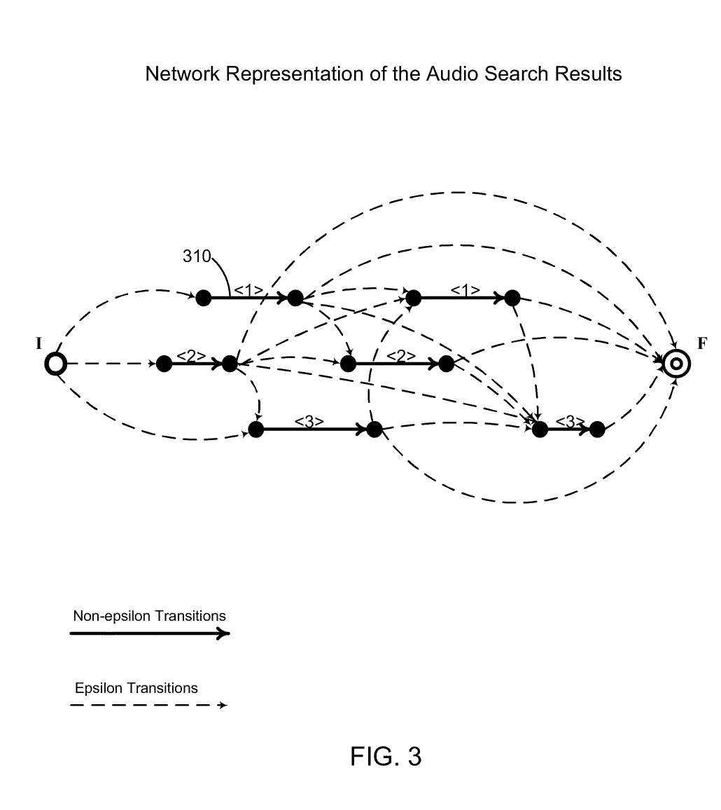

FIG. 3 shows one example of an FST representation of the search results shown in FIG. 2. In this example, the FST includes an initial state I and a final state F respectively labeled as a single ring and a double ring. The FST also includes a set of intermediate states, labeled as solid circles, each of which is defined in association with either the time onset T_{i,j}^{on} or the offset T_{i,j}^{off} of the hits generated by the lines as previously shown in FIG. 2.

In this FST, two types of transitions are allowed between states. The first type includes a set of non-ε transitions shown in solid arrows. Each non-ε transition progresses from a starting state associated with the time onset of a hit located by the search to an end state associated with the time offset of the same hit. For example, arrow 310 represents such a transition between the two states associated with audio segment A_{1,1} that was identified as a potential match for Line <1>. In this particular example, the output of this transition is defined as the text of the transcript line (i.e., Line <1>) whose search resulted in this hit. Other definitions of the transition output are also possible.

The second type of transitions, shown in dotted arrows, includes a set of ε-transitions formed in a substantially chronological manner. In other words, such a transition allows, in most cases, the FST to advance from a starting state only to an end state that is associated with a later time occurrence in the audio recording. As a result, the FST progresses in a way that conceptually allows the audio recording only to play forward rather than play backward. In practical implementations, there can be possible errors in time hypotheses, for example, as the putative locations identified by the wordspotting search may include a certain degree of variability. Thus, some implementations of the FST may in fact allow small deviations from strict chronological transitions.

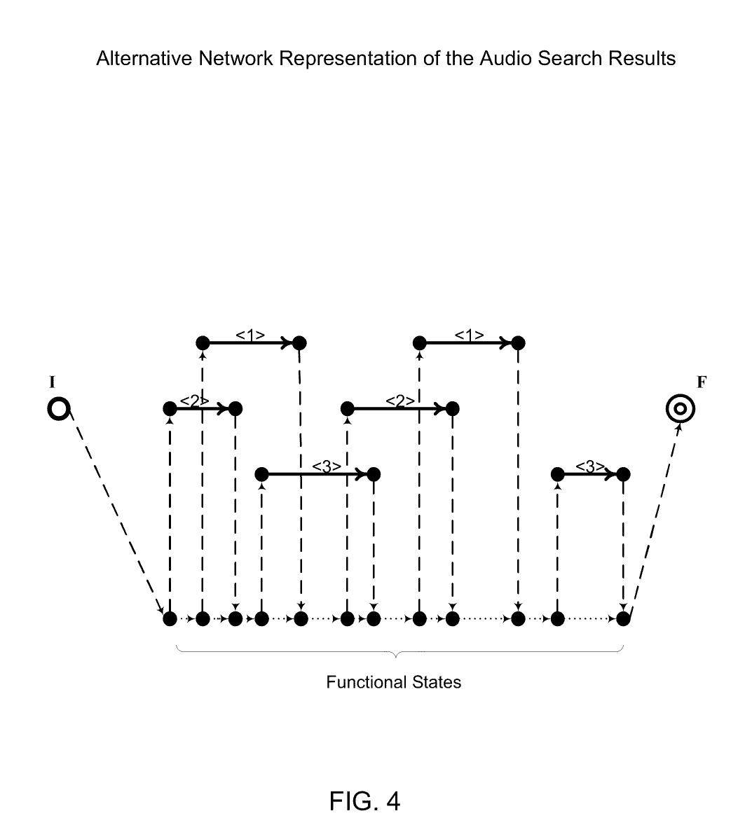

FIG. 4 shows another example of an FST representation of the search results shown in FIG. 2. This FST is formed according to a sequencing constraint similar to that of the FST of FIG. 3, but can perform the same function with a reduced number of ε, transitions between states. This is achieved by introducing an additional subset of intermediate states (labeled in the figure as “functional states”) in the FST and generating “forward mode” transitions between these newly introduced states. Without necessarily having to enumerate all possible ε transitions in the representation, this FST can perform the same functions as the FST of FIG. 3 in a more computationally efficient manner.

In some examples, the search results of the wordspotting procedure 150 may include, in addition to the putative locations of each search term, hypothesized speaker ID, hypothesized gender, and other information. These factors can also be modeled in the FST representation.

In addition, each transition may be associated with a weight, for example, as determined according to the confidence score characterizing the quality of the match between the line and the putative location of the line in the audio. Each acceptable sequence (path) of transitions in the FST can then be scored by combining (e.g., adding) the weights of the transitions in this sequence. This score can be later used in the composition of weighted finite state transducers to determine the most likely media-transcript alignment, as will be described later in this document.

### 2.2 FST REPRESENTATION OF THE TRANSCRIPT

As previously mentioned, a finite state network (e.g., an FST) is formed representing the set of acceptable sequences of lines of the transcript according to a second sequencing constraint. The determination of the sequencing constraint suitable for use for a particular transcript alignment application may depend on the specific context of that application. For example, in aligning a transcript that is not verbatim with the media, various types of complex scenarios may exist, some of which are discussed in detail below.

### 2.2.1 EXAMPLE I

The first scenario occurs when the transcript covers more content than the media does, or in other words, a substantial portion of the transcript is not spoken in the dialog of the media. For example, the transcript of an entire movie is provided to the transcript alignment system 100 to be aligned with an audio representation of only one scene of the movie. In such cases, it is desired not only to accurately align the lines spoken in the audio with those of the transcript, but also to identify which transcript lines were not spoken at all.

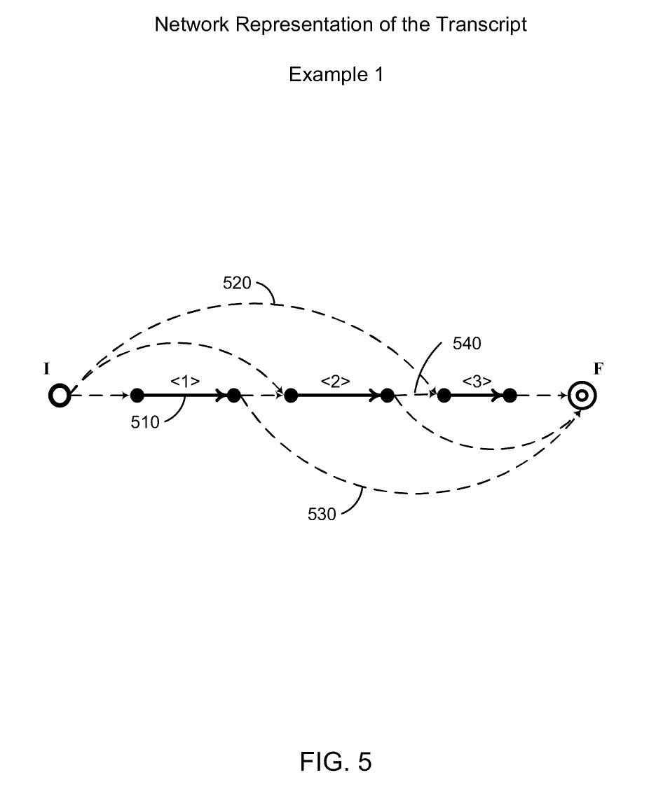

FIG. 5 shows an example of an FST representation of the transcript suitable for use in this scenario. Here, the FST includes an initial state I, a final state F, and a set of intermediate state each associated with the beginning or the end of a line in the transcript. Two types of transitions are allowed. The first type includes transitions advancing from a starting state associated with the beginning of a line to an end state associated with the end of the same line. One example of such a transition is shown as solid arrow 510 in the figure. The second type of transitions (shown in dotted arrows) includes a first subset of transitions advancing from the initial state I to states associated with the beginning of a line (e.g., arrow 520), a second subset of transitions advancing from states associated with the end of a line to the final state F (e.g., arrow 530), and a third subset of transitions that progresses between the intermediate states in a forward mode (e.g., arrow 540). In other words, this FST allows transition to start at any line of the transcript, move forward, and then exit at any subsequent line. Such an FST provides the flexibility that can allow a portion (rather than the entirety) of the transcript to be “walked” through, and thus can be used, for example, in cases where the transcript contains redundant sections not directly associated with the media.

### 2.2.2 EXAMPLE II

The second scenario occurs when the transcript does not cover the full content or the full dialog of the media. For example, the transcript for a scene is presented. The audio representation of this scene, however, may include several (possible incomplete) takes recorded in one continuous session. Each take may be a recitation of the same transcript with slight (and possibly different) verbal variations (e.g., changes in accent, word order, and speaker tone). Thus, the desired transcript alignment would result in a transcript line being identified with potentially more than one pair of start and end timestamps in the audio.

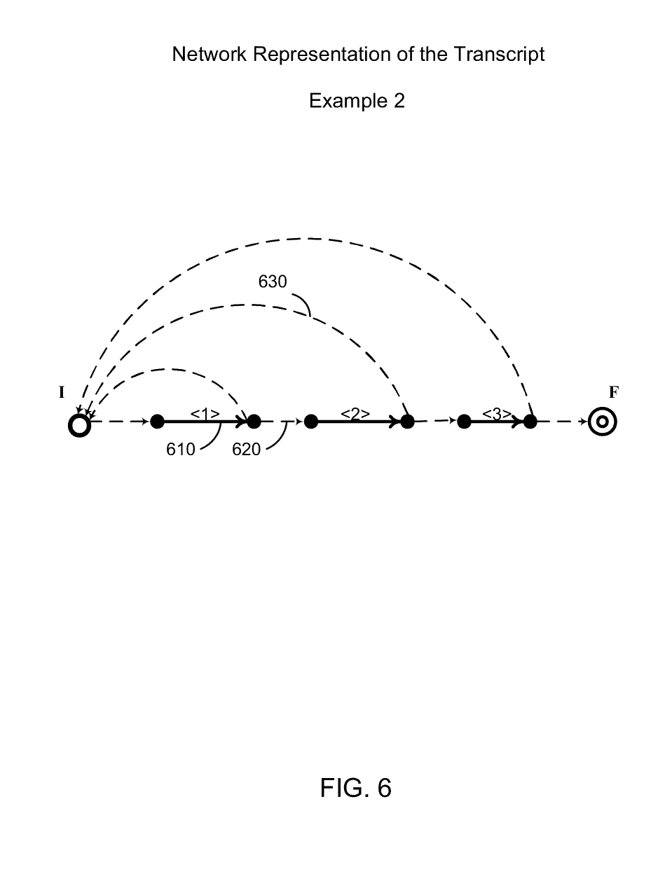

FIG. 6 shows an example of an FST representation of the transcript suitable for use in this scenario. Again, the FST includes an initial state I, a final state F, and a set of intermediate state each associated with the beginning or the end of a line in the transcript. The FST allows a first type of transitions (shown in solid arrows) advancing from a starting state associated with the beginning of a line to an end state associated with the end of the same line (e.g., arrow 610). The FST also allows a second type of transitions (show in dotted arrows) including a first subset of transitions that progresses between the intermediate states in a forward mode (e.g., arrow 620), and a second subset of transitions that returns from a state associated with the end of a line back to the initial state I (e.g. arrow 630). This provides an example of allowing transcript alignment with audio restarts, for example, when the audio begins with Line <1>, continues forward, and jumps back to the beginning.

### 2.2.3 EXAMPLE III

The third scenario occurs when an edited version of an original recording needs to be aligned with the transcript of the original recording. For example, a transcript of a speech (such as a presidential address) may exist. An edited report describing the speech may contain speech outside of that contained in the transcript, for example, remarks made by a commentator. The edited report may also present portions of the speech in a different order from what appears in the transcript, for example, as the commentator may bring up the final section of the speech first and then later talk about the previous sections.

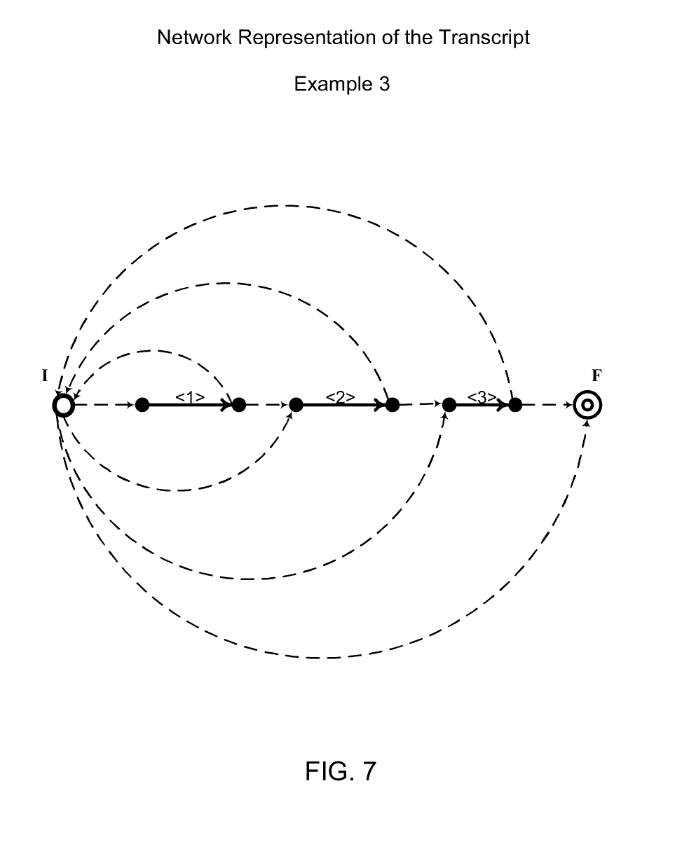

FIG. 7 shows an example of an FST representation of the transcript suitable for use in this scenario. In this FST, transitions can occur between any two states without a particularly constrained order. In other words, the FST is able to progress from any state toward another state in both back and forward mode. This type of FST can be useful in aligning transcript to an edited media, for example, that includes out-of-order contents.

In addition to the examples discussed above, other examples of FST can also be used to represent the set of acceptable sequences of lines of the transcript in various scenarios. Also, each transition may be associated with a weight, for example, as determined based on an estimate of transition likelihood according to additional semantic and/or syntactic information. The score of an acceptable sequence of transitions in the FST can be determined by combining (e.g. adding) the weights of each transition.

### 2.3 FST COMPOSITION

As discussed above, respective FST representations of the search results and the transcript can be constructed according to their corresponding sequencing constraints. Partial or complete alignment between the media and the transcript can then be determined by composing the two FSTs.

Very generally, a transducer can be understood as implementing a relation between sequences in its input and output alphabets. The composition of two transducers results in a new transducer that implements the composition of their relations.

In some aspects, composing two FSTs can be analogously viewed as an approach to solving a constraint satisfaction problem. That is, considering each FST as operating under a respective set of constraints, the composition of these two transducers forms a new transducer that operates in a manner that satisfies both sets of constraints. Put in the context of the transcript alignment application described above, a first FST representation of the search results provides a constrained set of acceptable sequences of subsets of the search results returned by the wordspotting procedure, and a second FST representation of the transcript provides a constrained set of acceptable sequences of lines of the transcript. The composition of these two FST then generates one or more output sequences that are acceptable to both FSTs. In other words, the result of the composition allows one to successfully “walk” through both networks in a time-synchronized fashion.

In some other aspects, FST composition can also be described in generalized mathematical forms. For example, let τ₁ represent the FST of the search results and τ₂ represent the FST of the transcript. The application of τ₂∘τ₁ (composition) to a sequence of input symbols (in some examples, input symbols are formed or selected from the input alphabets of the transducer and a sequence of input symbol can also be referred to as an input string s) can be computed by first considering all output strings associated with the input string s in the transducer τ₁, then applying τ₂ to all these output strings of τ₁. The output strings obtained after this application represent the result of this composition τ₂∘τ₁. In some examples of the transcript alignment application described above, the input strings to the transducer τ₁ can be defined as a set of time intervals, e.g., a set of [T_{i,j}^{ON}, T_{i,j}^{OFF}] as shown in FIG. 2. In this case, the output string of this transducer τ₁ is the line IDs, e.g., Line <1>, <2>, and <3>. The subsequent transducer τ₂ then accepts the line IDs as its input string and generates output strings that include one or more ordered sequences of line IDs. Each ordered sequence of line IDs can be viewed as a text that is “in sync” with the media. In other words, the output of τ₂∘τ₁ can be used to form a time-aligned transcript whose line sequence progresses along with the timeline of the media.

In some embodiments, at least one of the transducers τ₁ and τ₂ is a weighted transducer that accepts weights, for example, to state transitions. The score of an acceptable sequence of transitions in the weighted FST can then be determined by combining (e.g. adding) the weights of each transition that occurs in this sequence. This score can also be carried over to the composition operation to determine a score for each of the output string of the composition. In cases where both transducers are weighted, the output strings of the composition τ₂∘τ₁(s) can be scored by combining the weights associated with the state transitions that respectively occurred in the first and the second transducers. Based on these scores, a rank ordered set of N output strings can be extracted to describe the most likely N number of versions of the time-aligned transcript. If N equals 1, then the result is the single best time-aligned transcript for this media.

The scoring mechanism described above can accept additional outside information, such as penalties for time requirements. For example, if two states in transducer τ₁ are associated with two very distant timestamps in the media, the transition between these two states can be weighted down. Another example of outside information is context-based information such as, prior to a restart, there will be a minimum of one-minute of non-transcript audio. In this case, a corresponding constraint can be included in the transition weights of the transducer by incorporating scaled time differences. A third example of outside information that can be leveraged includes, for example, the knowledge that the person speaking lines 1, 3, 5 has a heavy accent, in which case the scores are expected to be lower for these lines. In general, any outside information of relevance can be modeled as a function of relative time, absolute time, line number, line scores (relative and/or absolute), speaker identification tags, emotional state analysis, and/or other metadata.

The composition of FSTs provides a useful approach to implement relations of complex finite state networks that represent speech-related applications. In some examples, the computation can be performed on-the-fly such that only the necessary part of the transducer needs to be expanded. Also, one can gradually apply τ₂ to the output strings of τ₁ instead of waiting for the result of the application of τ₁ to be completely determined. This can lead to improved computational efficiency in both time and space.

### 2.4 OTHER CONSIDERATIONS AND EXAMPLES

In some examples, there may be scenarios where, after the wordspotting procedure, no hit was found for a particular transcript line in the regions where the line (or some similar set of words) occurred. This may occur for several reasons, for example, as the transcript or the audio may be of poor quality, or the speaker of a particular line may have a heavy accent. In some cases, the alignment will then depend on the surrounding context to generate high enough scores to drive this alignment and for example, to rely on the use the functional states of FIG. 4 to skip missing lines. In situations where it is expected that the missing lines should appear in the time-aligned transcript, a heuristic approach can be used to estimate the onset and offset times for the missing lines, as describe below.

Consider a simple case where all lines of an original transcript need to appear and be in order in the time-aligned transcript. If a line k is missing from the FST composition, with no other information, the start of the missing line k could be hypothesized to be somewhere in the middle of a time bracket defined by the offset of the previous line k−1 and the onset of the following line k+1, according to an interpolation heuristic. For example, a known estimate for the average amount of time required to say three words in English can be subtracted from the time distance between the two endpoints of this time bracket. This time estimate is then divided by two and subsequently added to the left endpoint of the bracket. Further heuristics may also be used. In some examples, it is preferable to start playback a little early rather than risk losing the first word or two of a phrase. Thus, it may be desirable to guess even further to the left on the timeline to reduce this risk.

Note that in some examples, the transcript alignment procedure can be performed in a single stage that forms an alignment of the transcript to the media. In some other examples, the transcript alignment can be performed in successive stages. In each stage, a portion of the media (e.g., an individual take, daily, or segment) is aligned against all or a part of the transcript. The results of the successive stages are then bounded with the individual portions of the media from which the alignment results are derived. In cases where the media includes multiple multimedia asset segments that are likely to be rearranged in production, the time-aligned transcript can be conveniently recreated by rearranging the individual segments of the transcript that correspond to the multimedia asset segments.

### 3 APPLICATIONS

The above described transcript alignment approach can be useful in a number of speech or language-related applications. For example, the time-aligned transcript that is formed as a result of the transcript alignment procedure 170 can be used to generate closed captioning for media (e.g., a television program) that is robust to transcription gaps and errors. In another example, the time-aligned transcript can also be processed by a text translator (human or machine-based) to form any number of foreign language transcripts, e.g., a transcript containing German language text and a transcript containing French language text. Alignment of the foreign language transcript to the media can be further generated. The user 192 can then navigate the combined media and time-aligned native or foreign language transcripts using the interface 190. Detailed discussions of these examples and some further examples are provided in U.S. patent application Ser. No. 12/469,916 (Attorney Docket No. 30004-039001), the disclosure of which is incorporated herein by reference.

Another application relates to applying the transcript alignment approach to the sub-line domain. In the above description, a heuristic approach is used to hypothesize where a missing line might occur, in the absence of any other information. Another approach would be to gain more information, for example, to form sub-line alignments by finding matches to pieces of the line. Sub-line alignments can be performed using a process similar to the ones described above, except that instead of operating on the entire media file, this process operates on a selected bracketed region (e.g., the missing line). Also, instead of running search for full lines of the transcript, this approach can limit search to the ones that represent words and word phrases that make up the line in question.

One technique to perform such a sub-line alignment is to have one search for each word in the line. The search results for all searches within the bracketed region can be represented in an FST similar to that shown in FIG. 3 or FIG. 4. The line can be represented using an FST similar to that shown in FIG. 5, which allows the alignment to skip any number of words, but match as many as possible in a row. Note that deletions are still allowed due to the presence of functional states of the transducer of FIG. 4 that permits some lines (in this case, words) to be skipped.

The transcript alignment approaches described in this document can be particularly useful in the domain of media (e.g., audio, video, movie) production and editing. For example, the approaches provide robustness and graceful degradation to cases where the given transcript differs from audio in terms of scene sequence, lines spoken, or words used. Using these approaches, segments in the transcript that did not make into the final media product can also be identified, including for example, footage that was removed for it does not “advance” the movie, and cuts of individual lines or entire scenes. Further, transcript segments can be re-ordered to appear in the same sequence as shown in the edited media product.

In some examples, the results of the transcript alignment procedure can also be used to validate the original transcript provided to the system. For example, once the transcript alignment procedure forms an alignment of the transcript to the media, a subsequent validation procedure follows to validate the transcript, for example, by identifying areas of high transcription errors according to the result of alignment. This validation process can be conducted by associating each line/word with a respective score that characterizes the quality of the alignment. If a line (or a segment) of the transcript has been assigned a score below a threshold level, the line can be flagged as a poor transcription to alert subsequent processor or human user to correct that line (or segment), for example. Lines of the transcript that receive scores above the threshold level can also be evaluated, for example, via color coding, to determine whether there is a need for revision or correction.

The system can be implemented in software that is executed on a computer system. Different of the phases may be performed on different computers or at different times. The software can be stored on a computer-readable medium, such as a CD, or transmitted over a computer network, such as over a local area network.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A computer-implemented method for aligning a multimedia recording and a transcript, the method comprising:
forming a plurality of search terms from the transcript, each search term being associated with a location within the transcript;
determining putative locations of the search terms in a time interval of the multimedia recording, including for each search term, determining zero or more putative locations and, for at least some of the search terms, determining multiple putative locations in the time interval of the multimedia recording;
forming a first representation of a plurality of sequences each of a subset of the putative locations of the search terms according to a first sequencing constraint;
forming a second representation of a plurality of sequences each of a subset of the search terms; and
partially aligning the time interval of the multimedia recording and the transcript using the first and the second representations.

2. The computer-implemented method of claim 1, wherein the forming the second representation of a plurality of sequences each of a subset of the search terms includes forming the second representation according to a second sequencing constraint.

3. The computer-implemented method of claim 1, wherein the first sequencing constraint includes a time sequencing constraint.

4. The computer-implemented method of claim 3, wherein the time sequencing constraint includes a substantially chronological sequencing constraint.

5. The computer-implemented method of claim 1, wherein the first and the second representation respectively includes a first and a second network representation.

6. The computer-implemented method of claim 5, wherein the first and the second network representation respectively include a first and a second finite state network representation.

7. The computer-implemented method of claim 6, wherein the first and the second finite state network representation respectively includes a first and a second finite state transducer.

8. The computer-implemented method of claim 7, wherein partially aligning the time interval of the multimedia recording and the transcript includes composing the first finite state transducer with the second finite state transducer.

9. The computer-implemented method of claim 1, wherein determining putative locations of the search terms in a time interval of the multimedia recording includes associating each of the putative locations with a score characterizing a quality of a match of the search term and the corresponding putative location.

10. The computer-implemented method of claim 9, wherein forming the first representation includes determining a score for each sequence of subset of putative locations of the search terms using the scores of the putative locations of the search terms in the sequence.

11. The computer-implemented method of claim 10, wherein partially aligning the time interval of the multimedia recording and the transcript includes forming at least a partial alignment between a sequence of subset of the putative locations of the search terms and a sequence of search terms.

12. The computer-implemented method of claim 11, wherein forming the partial alignment includes determining a score for the partial alignment based at least on the score of the sequence of subset of the putative locations.

13. The computer-implemented method of claim 1, wherein the multimedia recording includes an audio recording.

14. The computer-implemented method of claim 1, wherein the multimedia recording includes a video recording.

15. The computer-implemented method of claim 1, wherein forming the search terms includes forming one or more search terms for each of a plurality of segments of the transcript.

16. The computer-implemented method of claim 15, wherein forming the search terms includes forming one or more search terms for each of a plurality of text lines of the transcript.

17. The computer-implemented method of claim 1, wherein determining the putative locations of the search terms includes applying a wordspotting approach to determine one or more putative locations for each of the search terms.
